(19) United States
(12) Patent Application Publication
(10) Pub. No.: US 2008/0162899 A1
(43) Pub. Date: Jul. 3, 2008

(54) COMPRESSED DATA TRANSFER APPARATUS AND METHOD FOR TRANSFERRING COMPRESSED DATA

(75) Inventor: Takanobu MUKAIDE, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/832,929

(22) Filed: Aug. 2, 2007

(30) Foreign Application Priority Data
Dec. 27, 2006 (JP) 2006-352222

(51) Int. Cl. G06F 9/44

(52) U.S. Cl. 712/225; 712/E09.016

(57) ABSTRACT

According to an embodiment, a compressed data transfer apparatus includes: a data size calculation unit that calculates a data size to be transferred to a decoding apparatus for a time period corresponding to a difference between a first decoding delay time for which a last decode unit data in a first compressed data resides in the decoding apparatus and a second decoding delay time for which a first decode unit data in a second compressed data successive to the first compressed data resides in the decoding apparatus when transferring the second compressed data successively to the first compressed data to the decoding apparatus; and a data size adjustment unit that adjusts a data size of the last decode unit data in the first compressed data to be matched with the data size calculated by the data size calculation unit.

### CROSS-REFERENCE TO RELATED APPLICATIONS

This application is based upon and claims the benefit of priority from Japanese Patent Application No. 2006-352222, filed Dec. 27, 2006, the entire contents of which are incorporated herein by reference.

### BACKGROUND

1. Field

One embodiment of the invention relates to a compressed data transfer apparatus and a method for transferring compressed data to a decoding apparatus.

2. Description Of the Related Art

In recent years, a disk reproducing apparatus for reading and reproducing video data and audio data from a storage medium such as an optical disk or a hard disk has been developed. The disk reproducing apparatus reads compressed data stored in the storage medium, decodes the compressed data, and reproduces the video data and audio data. WO2004/077825 discloses one example of an optical disk reproducing apparatus.

A data stream read from a disk-like storage medium is composed by connecting a plurality of compressed data encoded in accordance with a predetermined rule. Each compressed data is encoded individually, and additionally has the decoding start time determined by referring to individual reference time. When a plurality of compressed data are reproduced in succession, the decoding start time is determined by referring to a different reference time at the timing of switching from specific compressed data to another compressed data, whereby a buffer for the decoding apparatus may overflow or underflow.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram of a disk reproducing apparatus according to an embodiment of the present invention;

FIG. 2 is an exemplary view showing a data stream before the data processing according to the embodiment;

FIG. 3 is an exemplary view showing a data stream after the data processing according to the embodiment.

FIG. 4 is an exemplary first flowchart showing a data processing according to the embodiment;

FIG. 5 is an exemplary second flowchart showing a data processing according to the embodiment; and

FIG. 6 is an exemplary third flowchart showing a data processing according to the embodiment.

### DETAILED DESCRIPTION

Various embodiments according to the invention will be described hereinafter with reference to the accompanying drawings. In general, according to one embodiment of the invention, a compressed data transfer apparatus transfers a compressed data including a plurality of decode unit data to a decoding apparatus that decodes the compressed data. The plurality of decode unit data are encoded in accordance with a predetermined rule. The compressed data transfer apparatus includes: a data size calculation unit that calculates a data size to be transferred to the decoding apparatus for a time period corresponding to a difference between a first decoding delay time for which a last decode unit data in a first compressed data resides in the decoding apparatus and a second decoding delay time for which a first decode unit data in a second compressed data successive to the first compressed data resides in the decoding apparatus when transferring the second compressed data successively to the first compressed data to the decoding apparatus; and a data size adjustment unit that adjusts a data size of the last decode unit data in the first compressed data to be matched with the data size calculated by the data size calculation unit.

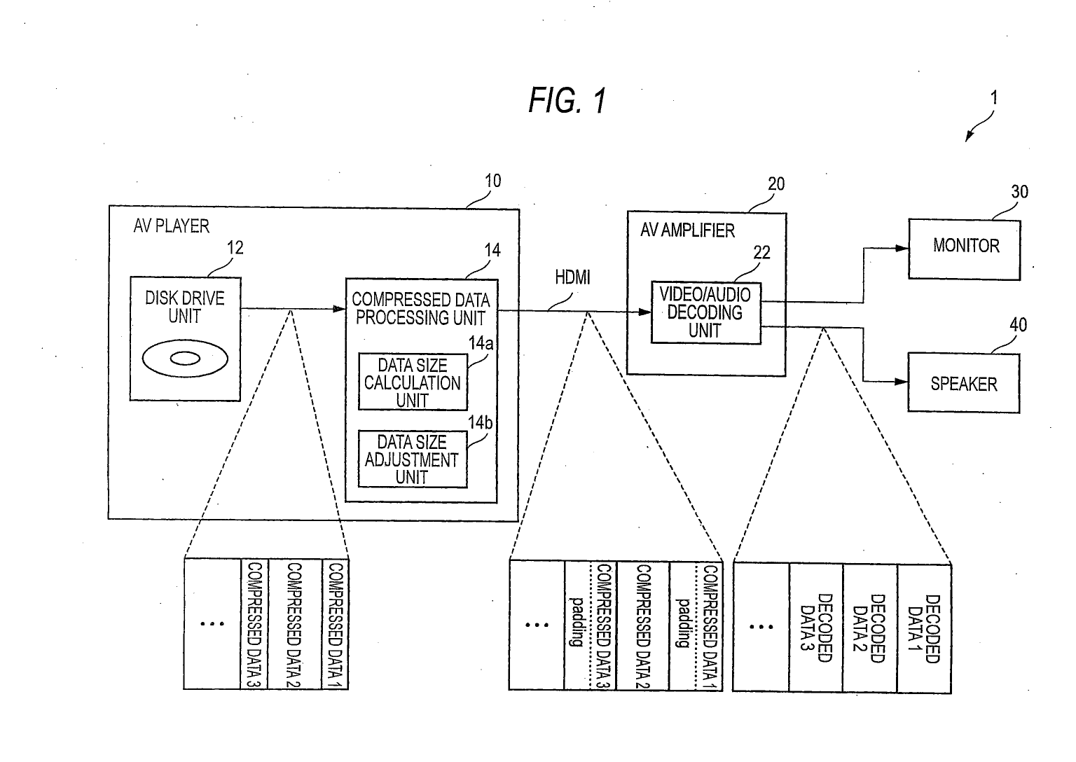

FIG. 1 is an exemplary block diagram of a disk reproducing apparatus 1 according to an embodiment of the present invention. The disk reproducing apparatus 1 reads and reproduces video data and audio data stored in a disk-like storage medium. The disk reproducing apparatus 1 comprises an Audio Visual (AV) player 10, an AV amplifier 20, a monitor 30, and a speaker 40. Herein, the AV player 10 and the AV amplifier 20 are connected via a cable conforming to a High-Definition Multimedia Interface (HDMI) standard.

Herein, the disk-like storage medium may be an optical disk such as a Digital Versatile Disc (DVD), a High Definition DVD (HD-DVD) or a Compact Disc (CD), or a magnetic disk such as a hard disk. The disk-like storage medium stores video data and audio data compressed in accordance with the general coding rules such as a Moving Picture Experts Group phase 2 (MPEG 2), an Audio Compression (AC) −3 and so on. The storage medium is not limited to the disk-like storage medium but may be any other kind of storage medium such as a semiconductor memory.

Data recorded in the disk-like storage medium is composed by connecting a plurality of compressed data encoded individually. And each of individually encoded compressed data includes the number of decode unit data. The decode unit data means a frame data as a processing unit at the time of decoding. For example, the decode unit data for video data is one frame of video data, and the decode unit data for audio data is a constant time of audio data. Each of decode unit data includes additionally the decoding start time information dst for starting to decode the decode unit data and the reproduction start time information pst for starting to reproduce the decode unit data. In other words, the decoding start time information dst is the time when the decode unit data is to be transferred from the compressed data transfer apparatus to the decoding apparatus. Also, the reproduction start time information pst is the time when the already decoded data in which the decode unit data is decoded is to be outputted from the decoding apparatus to the reproducing apparatus at the latter stage.

The decoding start time information dst and the reproduction start time information pst are determined by referring to the reference time that is different for each compressed data individually encoded. That is, when video data or audio data is encoded by an encoding apparatus, the decoding start time information dst and the reproduction start time information pst are determined, using the reference time referred to by the encoding apparatus. Hence, when a plurality of compressed data are decoded and reproduced in succession, the decoding start time information dst and the reproduction start time information pst are discontinuous at the switching timing of compressed data.

The compressed data such as video data and audio data is packed in a video pack or an audio pack and assembled, and converted into a format (DVD Video format) specified in accordance with a DVD/video standard or a format (DVD VR format) specified in accordance with a DVD recording standard. Such packed compressed data is recorded on the disk-like storage medium.

The AV player 10 comprises a disk drive unit 12 and a compressed data processing unit (compressed data transfer apparatus) 14. The disk drive unit 12 reads the compressed data from the disk-like storage medium, and outputs a read compressed data stream to the compressed data processing unit 14. The compressed data processing unit 14 has a data size calculation unit 14a for calculating proper data size and a data size adjustment unit 14b for adjusting the compressed data into the proper data size. If the compressed data stream is captured from the disk drive unit 12, the compressed data is adjusted into the proper data size by appending the padding data (usually 0 data) to the compressed data and outputted to the AV amplifier 20. Also, the compressed data processing unit 14 comprises a buffer memory, a demodulation processing unit and an error correction processing unit.

The AV amplifier 20 comprises a video/audio decoding unit (decoding apparatus) 22. The video/audio decoding unit 22 comprises a buffer memory for temporarily storing a compressed data stream received from the compressed data processing unit 14, and has a function of separating and extracting each pack from a DVD format signal having a pack structure, a function of decoding the separated video data (contents of video pack) and a function of decoding the separated audio data (contents of audio pack). If the video/audio decoding unit 22 captures the processed compressed data received via a signal line from the compressed data processing unit 14, the video/audio decoding unit 22 performs a separation process and a decoding process for this processed compressed data to generate a video signal and an audio signal. And the video/audio decoding unit 22 outputs the generated video signal to the monitor 30, and outputs the generated audio signal to the speaker 40.

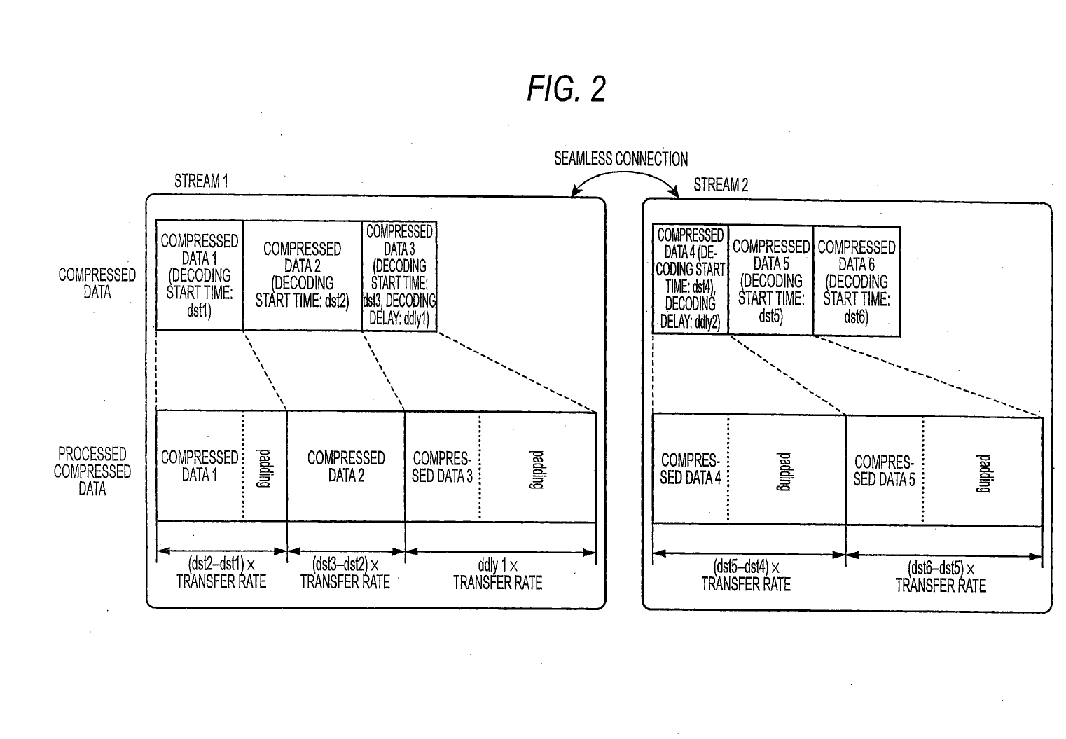

Particularly, the compressed data processing unit 14 performs a process for calculating the proper data size to transfer the compressed data even at the switching timing of compressed data streams in reproducing a plurality of compressed data streams individually compressed and encoded in succession. If the padding data appended to the last decode unit data of compressed data is too large, the first decode unit data of the successive compressed data is transferred from the compressed data processing unit 14 to the AV amplifier 20 with a delay from the decoding start time, so that the transferred compressed data is discarded at the decoder side, whereby there is a risk that underflow in the buffer memory for the AV amplifier 20 may occur, as shown in FIG. 2. Also, if the padding data appended to the last decode unit data of compressed data is too small, the first decode unit data of the successive compressed data is transferred from the compressed data processing unit 14 to the AV amplifier 20 ahead of the decoding start tine, whereby there is a risk that overflow in the buffer memory for the AV amplifier 20 may occur.

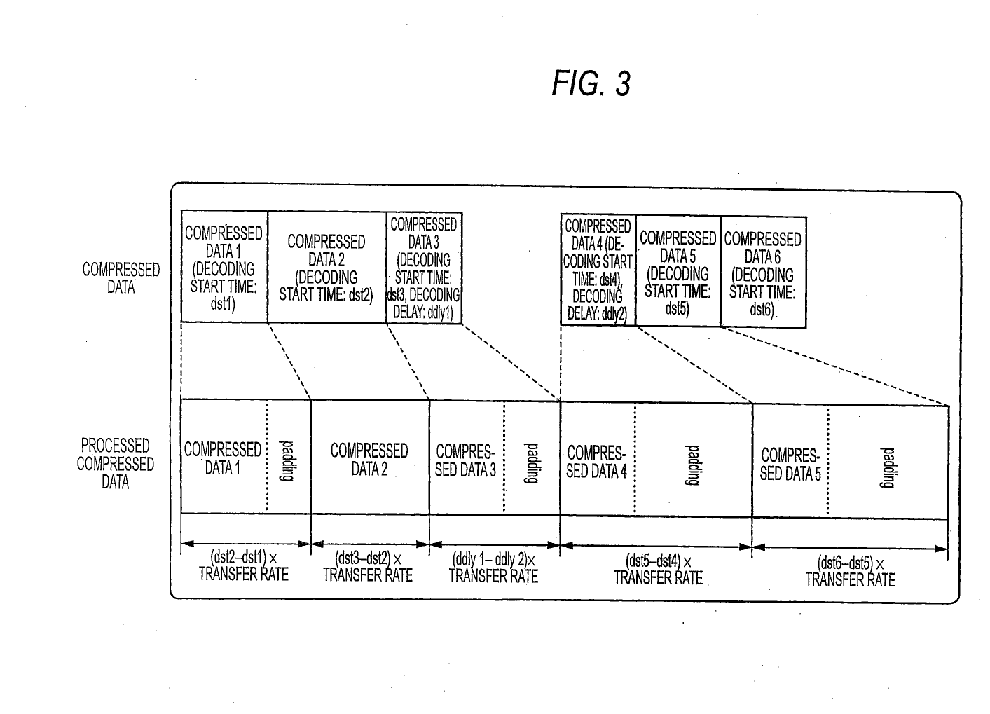

On the contrary, the compressed data processing unit 14 of this embodiment calculates a difference between a decoding delay time ddly1 for which the last decode unit data in the specific compressed data resides in the AV amplifier 20 and a decoding delay time ddly2 for which the first decode unit data in successive compressed data resides in the AV amplifier 20 and further calculates the data size dsz transferred to the AV amplifier for a period of time corresponding to the difference when transferring successive compressed data successive to the specific compressed data to the video/audio decoding unit 22, as shown in FIG. 3. Thereby, a plurality of compressed data can be connected seamlessly.

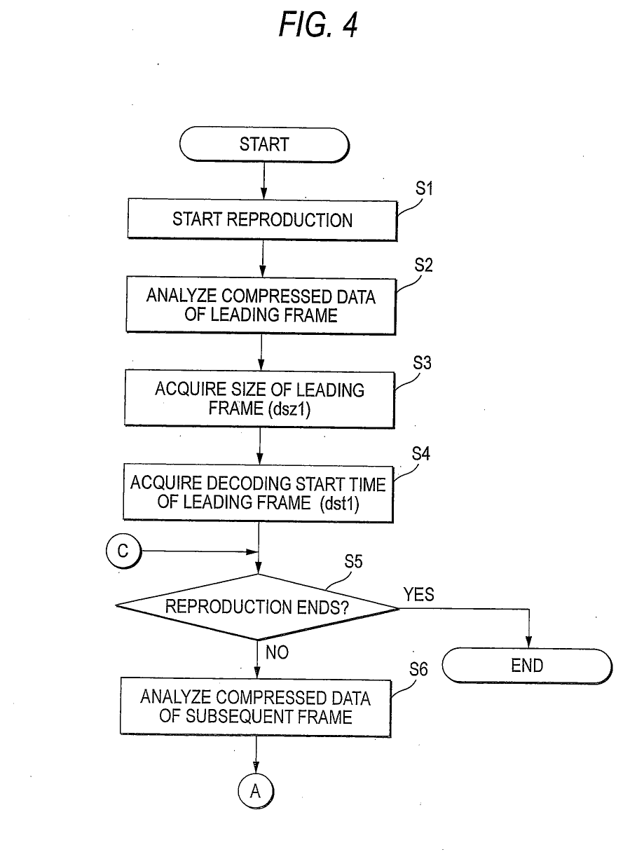

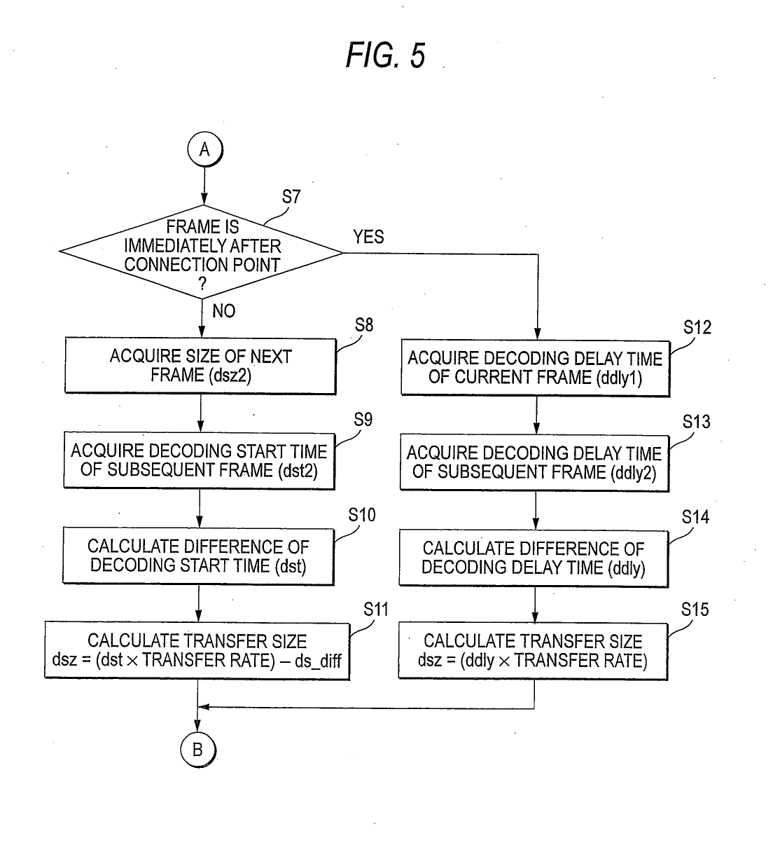

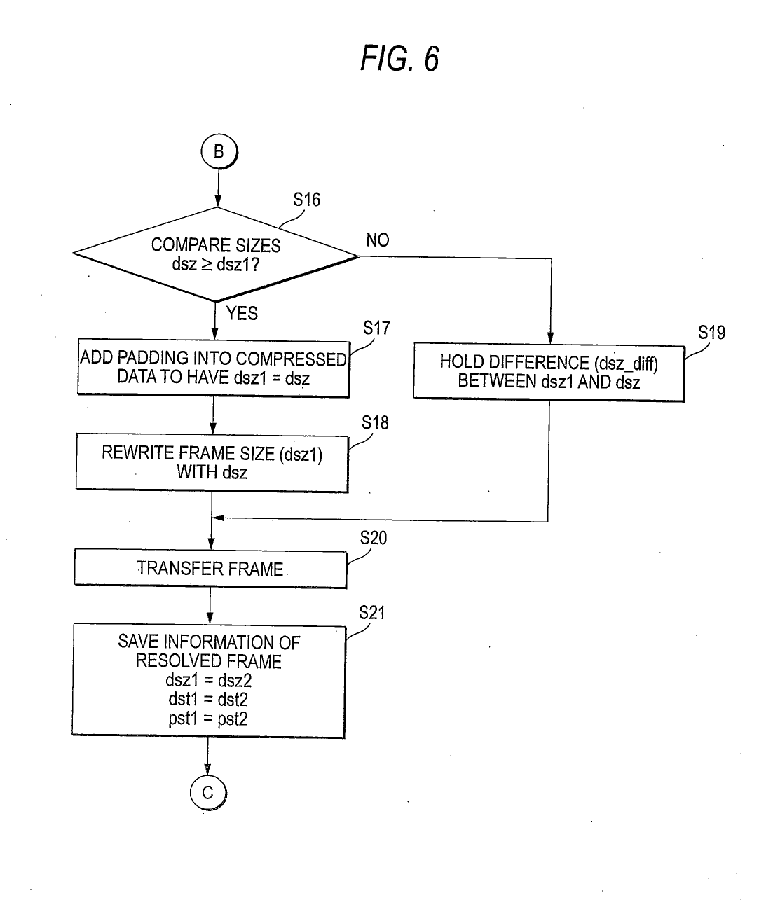

A data processing of the compressed data processing unit 14 will be described below in more detail. FIGS. 4, 5 and 6 are exemplary flowcharts showing the data processing of the compressed data processing unit 14.

If the disk reproducing apparatus 1 starts the reproducing operation of video data and audio data (S1), the compressed data processing unit 14 analyzes the compressed data of the leading frame (S2) and acquires the frame size dsz1 of the leading frame (S3), and the decoding start time dst1 and the reproduction start time pst1 of the leading frame (S4).

The compressed data processing unit 14 determines whether or not the reproducing operation is ended (S5). Herein, if the compressed data processing unit 14 determines that the reproducing operation does not end, the process ends. On the other hand, if the compressed data processing unit 14 determines that the reproducing operation ends, the operation goes to block S6.

At step S6, the compressed data processing unit 14 analyzes the compressed data of the subsequent frame. And the compressed data processing unit 14 determines whether or not the subsequent frame is immediately after the connection point, based on the result of this analysis (S7). Herein, if the compressed data processing unit 14 determines that the subsequent frame is not immediately after the connection point, the operation goes to block S8. On the other hand, the compressed data processing unit 14 determines that the subsequent frame is immediately after the connection point, the operation goes to block S12.

At blocks S8 and S9, the compressed data processing unit 14 acquires the frame size dsz2 and the decoding start time dst2 of the subsequent frame. At blocks S10 and S11, the compressed data processing unit 14 calculates a decoding start time difference dst between the leading frame and the subsequent frame subsequent to the leading frame, and calculates the transfer data size dsz by multiplying the calculated decoding start time difference dst by the data transfer rate to the video/audio decoding unit 22. At block S11, the compressed data processing unit 14 calculates the transfer data size by subtracting the data size dsz_diff from the decoding start time difference dst multiplied by the data transfer rate, if it holds the data size dsz_diff corresponding to the transfer delay time α. Thereafter, the compressed data processing unit 14 goes to block S16.

On the other hand, at block S12, the compressed data processing unit 14 calculates a difference by subtracting the decoding start time from the reproduction start time of the leading frame of current processing object, and acquires the difference as the decoding delay time ddly1 for which the leading frame resides in the video/audio decoding unit 22. Subsequently, at block S13, the compressed data processing unit 14 calculates a difference by subtracting the decoding start time from the reproduction start time of the subsequent frame, and acquires the difference as the decoding delay time ddly2 for which the subsequent frame resides in the video/audio decoding unit 22. And at blocks S14 and S15, the compressed data processing unit 14 calculates a decoding delay time difference ddly by subtracting the decoding delay time ddly2 of the subsequent frame from the decoding delay time ddly1 of the leading frame, and calculates the transfer data size dsz by multiplying the calculated decoding delay time difference ddly by the data transfer rate to the video/audio decoding unit 22. Thereafter, the compressed data processing unit 14 goes to block S16.

Thereafter, at block S16, the compressed data processing unit 14 compares the calculated transfer data size dsz and the frame size dsz1 of the leading frame, and determines whether or not dsz is greater than or equal to dsz1. Herein, if the compressed data processing unit 14 determines that dsz is greater than or equal to dsz1, the operation goes to block S17. On the other hand, if the compressed data processing unit 14 determines that dsz is not greater than or equal to dsz1, the operation goes to block S19.

At block S17, the compressed data processing unit 14 adds the padding data to the leading frame to equalize dsz1 and dsz so that the data size dsz1 of the leading frame 1 matches with the data size dsz calculated at block S11 or block S15. Also, at block S18, the compressed data processing unit 14 rewrites the frame size dsz1 of the leading frame with the size dsz in which the padding data is appended.

On the other hand, at block S19, the compressed data processing unit 14 holds a difference between dsz1 and dsz, viz., dsz1−dsz=dsz_diff. This data size dsz_diff is used at block S15. A transfer delay occurring where dsz<dsz1 can be resolved at block S15. The data size dsz_diff is zero immediately after the reproduction starts.

At block S20, the compressed data processing unit 14 transfers the leading frame that has been processed (or may not have been processed) to the video/audio decoding unit 22. At block S21, the compressed data processing unit 14 saves the information of the subsequent frame. That is, the compressed data processing unit 14 holds the value held as the frame size dsz2 as the value of the frame size dsz1, and holds the value held as the reproduction start time dst2 as the value of the reproduction start time dst1. And the compressed data processing unit 14 holds the value held as the reproduction start time pst2 as the value of the reproduction start time pst1. Thereby, the required information for calculating the frame size dsz is held in the following process in which the second frame is the processing object.

Thereafter, the operation returns to block S5, the frame transfer process for the second frame of processing object is continued. Further, the frame transfer process for each of the third and following frames of processing object is repeated in the same manner. Particularly in this embodiment, advantageously, when the last frame of compressed data is the processing object, the operation goes from block S7 to block S12, where the frame size for the connection point of compressed data is calculated.

With the disk reproducing apparatus 1 of this embodiment, the transfer size dsz of the frame immediately before the connection point is determined at the connection point between two data streams, based on the decoding delay time ddly1 of the frame immediately before the connection point and the decoding delay time ddly2 of the frame immediately after the connection point, whereby two data streams encoded individually can be connected seamlessly. And since two data streams are connected seamlessly in this manner, an overflow or underflow of the buffer memory for the video/audio decoder unit 22 can be prevented.

In other words, it is possible to provide a data transfer apparatus and a data transfer method capable of connecting a data stream of a plurality of compressed data seamlessly.

That is, in this embodiment, the data size dst obtained at blocks S12 to S15 is made the data size of the frame immediately before the connection point at the connection point between two data streams, so that a free space required for storing the frame immediately after the connection point is reserved in the buffer memory of the video/audio decoding unit 22, whereby an overflow of the buffer memory can be prevented. Also, the data size dst obtained at blocks S12 to S15 is not too small, and the frame immediately before the connection point surely exists in the buffer memory when the frame immediately after the connection point is stored, whereby an underflow of the buffer memory can be prevented.

Also, with the disk reproducing apparatus 1 of this embodiment, since two data streams are connected seamlessly in the compressed data processing unit 14 on the upstream side thereof, the decoding process can be normally performed in the video/audio decoder unit 22 on the downstream side. Hence, in the above embodiment, the AV amplifier 20 can fully slave to the AV player 10, so that the decoding part of the AV amplifier 20 can easily perform the decoding process.

In the disk reproducing apparatus 1 of the above embodiment, the AV player 10 and the AV amplifier 20 that are separate AV apparatuses are connected via an HDMI cable, but the invention is not limited thereto. For example, the disk reproducing apparatus 1 may be one AV apparatus, and the compressed data processing unit 14 and the video/audio decoding unit 22 that are separate devices may be connected via the wiring inside this one AV apparatus.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. A compressed data transfer apparatus that transfers a compressed data including a plurality of decode unit data to a decoding apparatus that decodes the compressed data, the plurality of decode unit data being encoded in accordance with a predetermined rule, the compressed data transfer apparatus comprising:
a data size calculation unit that calculates a data size to be transferred to the decoding apparatus for a time period corresponding to a difference between a first decoding delay time for which a last decode unit data in a first compressed data resides in the decoding apparatus and a second decoding delay time for which a first decode unit data in a second compressed data successive to the first compressed data resides in the decoding apparatus when transferring the second compressed data successively to the first compressed data to the decoding apparatus; and
a data size adjustment unit that adjusts a data size of the last decode unit data in the first compressed data to be matched with the data size calculated by the data size calculation unit.

2. The compressed data transfer apparatus according to claim 1,
wherein the last decode unit data in the first compressed data includes a first decoding start time information indicating a first time when the last decode unit data in the first compressed data is to be transferred from the compressed data transfer apparatus to the decoding apparatus and a first reproduction start time information indicating a second time when a decoded data of the last decode unit data in the first compressed data is to be outputted from the decoding apparatus to a reproducing apparatus at a latter stage,
wherein the data size calculation unit calculates the first decoding delay time by subtracting the first time from the second time,
wherein the first decode unit data in the second compressed data includes a second decoding start time information indicating a third time when the first decode unit data in the second compressed data is to be transferred from the compressed data transfer apparatus to the decoding apparatus and a second reproduction start time information indicating a fourth time when a decoded data of the first decode unit data in the second compressed data is to be outputted from the decoding apparatus to the reproducing apparatus, and
wherein the data size calculation unit calculates the second decoding delay time by subtracting the third time from the fourth time.

3. The compressed data transfer apparatus according to claim 1,
wherein the data size adjustment unit matches the data size of the last decode unit data in the first compressed data with the data size calculated by the data size calculation unit by adding a padding data to the last decode unit data in the first compressed data.

4. The compressed data transfer apparatus according to claim 1,
wherein the data size calculation unit calculates the data size to be transferred to the decoding apparatus by multiplying the time period corresponding to the difference between the first and second decoding delay times by a data transfer rate from the compressed data transfer apparatus to the decoding apparatus.

5. The compressed data transfer apparatus according to claim 1,
wherein the compressed data includes at least one of a video data and an audio data which are encoded in accordance with the predetermined rule.

6. The compressed data transfer apparatus according to claim 1,
wherein the compressed data transfer apparatus and the decoding apparatus are connected via a cable conforming to a High-Definition Multimedia Interface standard.

7. A method for transferring a compressed data including a plurality of decode unit data to a decoding apparatus, the plurality of decode unit data being encoded in accordance with a predetermined rule, the method comprising:
calculating a data size to be transferred to the decoding apparatus for a time period corresponding to a difference between a first decoding delay time for which a last decode unit data in a first compressed data resides in the decoding apparatus and a second decoding delay time for which a first decode unit data in a second compressed data successive to the first compressed data resides in the decoding apparatus when transferring the second compressed data successively to the first compressed data to the decoding apparatus; and
adjusting a data size of the last decode unit data in the first compressed data to be matched with the calculated data size.

8. The method according to claim 7,
wherein the last decode unit data in the first compressed data includes a first decoding start time information indicating a first time when the last decode unit data in the first compressed data is to be transferred from the compressed data transfer apparatus to the decoding apparatus and a first reproduction start time information indicating a second time when a decoded data of the last decode unit data in the first compressed data is to be outputted from the decoding apparatus to a reproducing apparatus at a latter stage,
wherein the first decode unit data in the second compressed data includes a second decoding start time information indicating a third time when the first decode unit data in the second compressed data is to be transferred from the compressed data transfer apparatus to the decoding apparatus and a second reproduction start time information indicating a fourth time when a decoded data of the first decode unit data in the second compressed data is to be outputted from the decoding apparatus to the reproducing apparatus, and
wherein the calculating step comprises subtracting the first time from the second time to calculate the first decoding delay time, and
wherein the calculating step comprises subtracting the third time from the fourth time to calculate the second decoding delay time.

9. The method according to claim 7,
wherein the adjusting step comprising adding a padding data to the last decode unit data in the first compressed data to match the data size of the last decode unit data in the first compressed data with the calculated data size.

10. The method according to claim 7,
wherein the calculating step comprising multiplying the time period corresponding to the difference between the first and second decoding delay times by a data transfer rate from the compressed data transfer apparatus to the decoding apparatus to calculate the data size to be transferred to the decoding apparatus.
